(19) United States
(12) Patent Application Publication
(10) Pub. No.: US 2026/0238867 A1
(43) Pub. Date: Aug. 13, 2026

(54) ELECTRONIC DEVICE INCLUDING CAMERA COVER FOR FORMING ESD DISCHARGE PATH

(71) Applicant: Samsung Electronics Co., Ltd., Suwon-si (KR)

(72) Inventors: Jonghyeok JEON, Suwon-si (KR); Sanguk KIM, Suwon-si (KR); Heewon CHOI, Suwon-si (KR); Cheungwon RYU, Suwon-si (KR); Chanyang PARK, Suwon-si (KR); Joosung KIM, Suwon-si (KR); Jongmin KIM, Suwon-si (KR)

(21) Appl. No.: 19/404,505

(22) Filed: Dec. 1, 2025

Related U.S. Application Data
(63) Continuation of application No. PCT/KR2025/019185, filed on Nov. 19, 2025.

(30) Foreign Application Priority Data
Feb. 7, 2025 (KR) 10-2025-0016187
Mar. 7, 2025 (KR) 10-2025-0030160

(51) Int. Cl. H04N 23/52; G03B 11/04; H04M 1/02

(52) U.S. Cl. CPC H04N 23/52; G03B 11/04; H04M 1/0203; H04M 1/0264

(57) ABSTRACT

An electronic device is provided. The electronic device includes a non-conductive rear cover, including a first surface defining at least a portion of a rear exterior of the electronic device and a second surface opposite to the first surface the non-conductive rear cover defining an opening, a non-conductive camera cover, covering the opening of the non-conductive rear cover, including a light transmittance portion, a camera disposed below the light transmittance portion of the non-conductive camera cover, to be aligned with the light transmittance portion of the non-conductive camera cover, a conductive ring, attached to the first surface of the non-conductive rear cover, surrounding the non-conductive camera cover, and a conductive frame configured to fix the non-conductive camera cover to the non-conductive rear cover, the conductive frame at least partially overlapping the conductive ring and being spaced apart from the conductive ring, wherein the conductive frame is electrically connected to a ground of the electronic device such that the conductive ring is electrically connected to the ground of the electronic device through an electrical coupling with the conductive frame spaced apart from the conductive ring.

### CROSS-REFERENCE TO RELATED APPLICATION(S)

This application is a continuation application, claiming priority under 35 U.S.C. § 365(c), of an International application No. PCT/KR2025/019185, filed on Nov. 19, 2025, which is based on and claims the benefit of a Korean patent application number 10-2025-0016187, filed on Feb. 7, 2025, in the Korean Intellectual Property Office, and of a Korean patent application number 10-2025-0030160, filed on Mar. 7, 2025, in the Korean Intellectual Property Office, the disclosure of each of which is incorporated by reference herein in its entirety.

### TECHNICAL FIELD

The disclosure relates to an electronic device including a camera cover for forming an electrostatic discharge (ESD) discharge path.

### BACKGROUND ART

An electronic device such as a smartphone may include a camera and a camera cover (e.g., a camera decoration member) for protecting the camera. Meanwhile, due to an electrostatic discharge (ESD), a component (e.g., the camera) or circuitry inside the electronic device may malfunction or be damaged.

The above information is presented as background information only to assist with an understanding of the disclosure. no determination has been made, and no assertion is made, as to whether any of the above might be applicable as a prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device including a camera cover for forming an ESD discharge path.

Additional aspects will be set forth in part in the description which follows and, in part, will be apparent from the description, or may be learned by practice of the presented embodiments.

In accordance with an aspect of the disclosure, an electronic device is provided. The electronic device includes a non-conductive rear cover, including a first surface defining at least a portion of a rear exterior of the electronic device and a second surface opposite to the first surface the non-conductive rear cover defining an opening, a non-conductive camera cover, covering the opening of the non-conductive rear cover, including a light transmittance portion, a camera disposed below the light transmittance portion of the non-conductive camera cover, to be aligned with the light transmittance portion of the non-conductive camera cover, a conductive ring, attached to the first surface of the non-conductive rear cover, surrounding the non-conductive camera cover, and a conductive frame configured to fix the non-conductive camera cover to the non-conductive rear cover, the conductive frame at least partially overlapping the conductive ring and being spaced apart from the conductive ring, wherein the conductive frame is electrically connected to a ground of the electronic device such that the conductive ring is electrically connected to the ground of the electronic device through an electrical coupling with the conductive frame spaced apart from the conductive ring.

In accordance with another aspect of the disclosure, an electronic device is provided. The electronic device includes a non-conductive rear cover, including a first surface defining at least a portion of a rear exterior of the electronic device and a second surface opposite to the first surface, the non-conductive rear cover defining an opening, a non-conductive camera cover, attached to the first surface of the non-conductive rear cover to cover the opening of the non-conductive rear cover, the non-conductive camera cover including a light transmittance portion, a camera, disposed below the light transmittance portion of the non-conductive camera cover, configured to receive light through the light transmittance portion of the non-conductive camera cover, a conductive protective member disposed on the first surface of the non-conductive rear cover, surrounding a periphery portion of the non-conductive camera cover, a conductive frame, attached to the second surface of the non-conductive rear cover to at least partially overlap the conductive protective member, a non-conductive plate, disposed below the conductive frame, and a conductive pattern, formed on the non-conductive plate, spaced apart from the conductive frame, and at least partially overlapping the conductive frame, wherein the conductive protective member is electrically connected to a ground of the electronic device through the conductive frame, spaced apart from the conductive protective member, electrically coupled to the conductive protective member, and the conductive pattern, spaced apart from the conductive frame, electrically coupled to the conductive frame.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a diagram indicating an electronic device according to an embodiment of the disclosure;

FIG. 2B is an exploded perspective view of an electronic device according to an embodiment of the disclosure;

FIGS. 3 and 4 are diagrams indicating a rear surface of an electronic device, according to various embodiments of the disclosure;

FIGS. 5 and 6 are exploded perspective views of an electronic device, according to various embodiments of the disclosure;

FIG. 7 is a transparency diagram indicating a camera region of an electronic device, according to an embodiment of the disclosure;

FIG. 8 indicates a coupling structure between a camera cover and a conductive frame, according to an embodiment of the disclosure;

FIG. 9 is a cross-sectional view of an electronic device, according to an embodiment of the disclosure;

FIG. 10 is a planar view of an electronic device, according to an embodiment of the disclosure;

FIG. 11 is a block diagram indicating an ESD discharge path of an electronic device, according to an embodiment of the disclosure;

FIG. 12 is a block diagram indicating an ESD discharge path of an electronic device to a comparative example according to an embodiment of the disclosure;

FIG. 13 is a cross-sectional view of an electronic device to a comparative example according to an embodiment of the disclosure;

FIG. 14 is a block diagram of an electronic device, according to an embodiment of the disclosure; and

FIG. 15 is a block diagram of an electronic device, according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

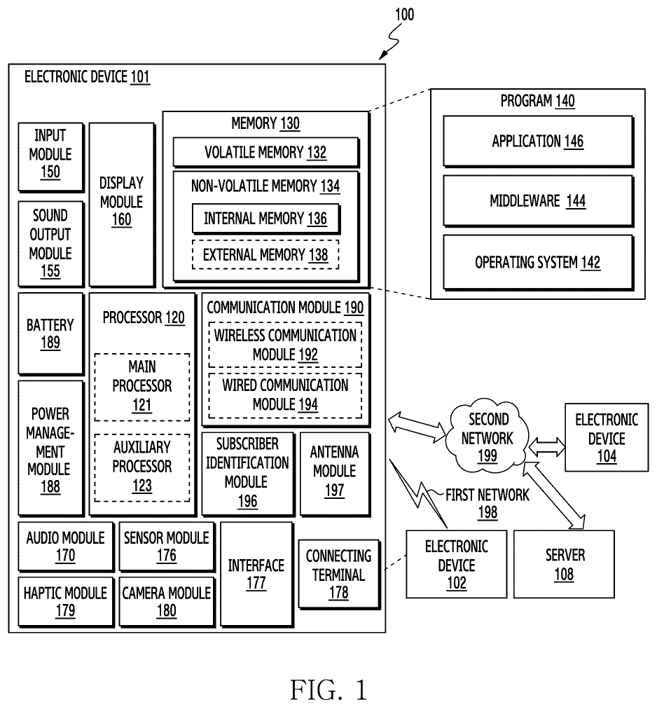

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

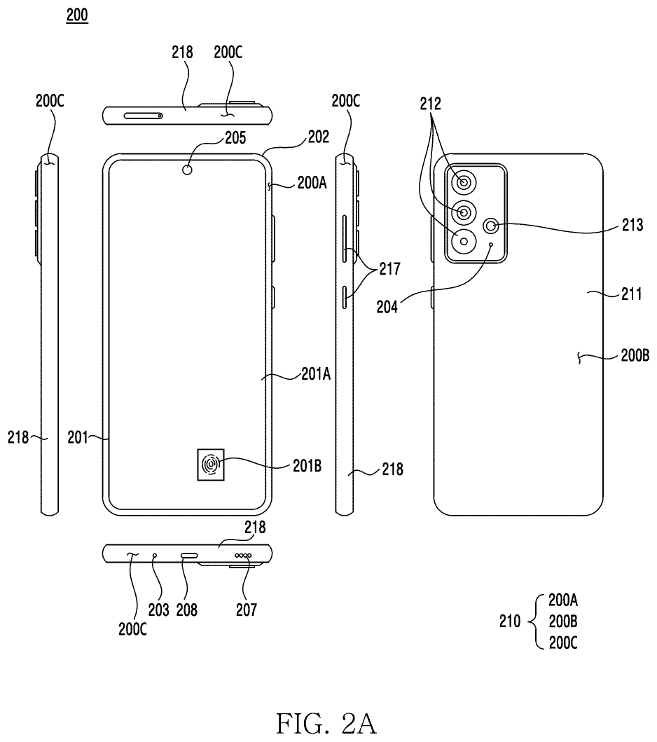

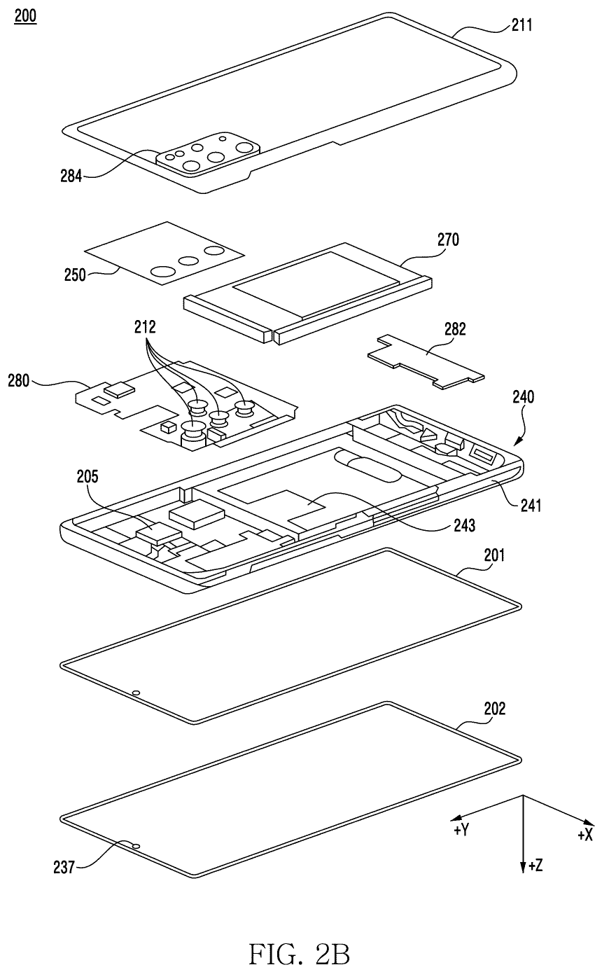

FIG. 2A is a diagram indicating an electronic device according to an embodiment of the disclosure.

Referring to FIG. 2A, according to an embodiment, an electronic device 200 may include a housing 210 at least partially forming an exterior of the electronic device 200. For example, the housing 210 may include a first surface (or a front surface) 200A, a second surface (a rear surface) 200B, and a third surface (or a lateral surface) 200C surrounding a space between the first surface 200A and the second surface 200B. In an embodiment, the housing 210 may refer to a structure forming at least a portion of the first surface 200A, the second surface 200B, and/or the third surface 200C.

According to an embodiment, the electronic device 200 may include a substantially transparent front plate 202. In an embodiment, the front plate 202 may form at least a portion of the first surface 200A. In an embodiment, the front plate 202 may include, for example, a glass plate or a polymer plate, including various coating layers, but is not limited thereto.

According to an embodiment, the electronic device 200 may include a substantially opaque rear plate 211. In an embodiment, the rear plate 211 may form at least a portion of the second surface 200B. In an embodiment, the rear plate 211 may be formed of a non-conductive material. For example, the rear plate 211 may be formed of coated or colored glass, ceramic, polymer, or a combination of at least two of the materials.

According to an embodiment, the electronic device 200 may include a lateral surface bezel structure (or a lateral surface member) 218. In an embodiment, the lateral surface bezel structure 218 may form at least a portion of the third surface 200C of the electronic device 200, by being coupled to the front plate 202 and/or the rear plate 211. For example, the lateral surface bezel structure 218 may form the entire third surface 200C of the electronic device 200, and for another example, the lateral surface bezel structure 218 may form the third surface 200C of the electronic device 200 together with the front plate 202 and/or the rear plate 211.

In an embodiment, the lateral surface bezel structure 218 may include a metal and/or polymer. In an embodiment, the rear plate 211 and the lateral surface bezel structure 218 may be integrally formed, and may include the same material (e.g., a metal material such as aluminum), but are not limited thereto. For example, the rear plate 211 and the lateral surface bezel structure 218 may also be formed in separate configurations and/or may include different materials.

In an embodiment, the electronic device 200 may include a display 201 (e.g., the display module 160 of FIG. 1), audio modules 203, 204, and 207 (e.g., the audio module 170 of FIG. 1), a sensor module (e.g., the sensor module 176 of FIG. 1), camera modules 205, 212, and 213 (e.g., the camera module 180 of FIG. 1), a key input device 217 (e.g., the input module 150 of FIG. 1), a light emitting element (not illustrated), and a connector hole 208. In an embodiment, the electronic device 200 may omit at least one (e.g., the key input device 217 or the light emitting device (not illustrated)) of the components or may additionally include another component.

In an embodiment, the display 201 may be visually exposed through a significant portion of the front plate 202. For example, at least a portion of the display 201 may be visible through the front plate 202 forming the first surface 200A. The display 201 may be disposed on a back surface of the front plate 202.

In an embodiment, the display 201 (or the first surface 200A of the electronic device 200) may include a screen display region 201A. In an embodiment, the display 201 may provide visual information to a user through the screen display region 201A. In the illustrated embodiment, when the first surface 200A is viewed frontally, the screen display region 201A is illustrated to be spaced apart from an outer periphery of the first surface 200A and positioned in the inside of the first surface 200A, but is not limited thereto. For example, when the first surface 200A is viewed frontally, at least a portion of a periphery of the screen display region 201A may substantially coincide with a periphery of the first surface 200A (or the front plate 202).

In an embodiment, the screen display region 201A may include a sensing region 201B configured to obtain biometric information of the user. Herein, a meaning of “the screen display region 201A includes the sensing region 201B” may be understood as that at least a portion of the sensing region 201B may be overlapped with the screen display region 201A. For example, the sensing region 201B, like another region of the screen display region 201A, may mean a region capable of displaying visual information by the display 201 and additionally obtaining biometric information (e.g., fingerprint) of the user. Although the sensing region 201B is illustrated to be formed in the screen display region 201A, it is not limited thereto. For example, the sensing region 201B may also be formed in the key input device 217.

In an embodiment, the display 201 may include a region in which the first camera module 205 is positioned. For example, an opening portion is formed in the region of the display 201, and the first camera module 205 (e.g., a punch hole camera) may be at least partially disposed in the opening portion to face the first surface 200A. In this case, the screen display region 201A may surround at least a portion of a periphery of the opening portion. In an embodiment, the first camera module 205 (e.g., an under display camera (UDC)) may be disposed below the display 201 to overlap with the region of the display 201. In this case, the display 201 may provide visual information to the user through the region, and additionally, the first camera module 205 may obtain an image corresponding to a direction facing the first surface 200A through the region of the display 201.

In an embodiment, the display 201 may be coupled with or disposed adjacent to touch sensing circuitry, a pressure sensor capable of measuring a strength (pressure) of a touch, and/or a digitizer that detects a magnetic field-type stylus pen.

In an embodiment, the audio modules 203, 204, and 207 may include the microphone holes 203 and 204 and the speaker hole 207.

In an embodiment, the microphone holes 203 and 204 may include the first microphone hole 203 formed in a partial region of the third surface 200C, and the second microphone hole 204 formed in a partial region of the second surface 200B. A microphone for obtaining an external sound may be disposed inside the microphone holes 203 and 204. The microphone may include a plurality of microphones to detect a direction of a sound, but is not limited thereto.

In an embodiment, the second microphone hole 204 formed in the partial region of the second surface 200B may be disposed adjacent to the camera modules 205, 212, and 213. For example, the second microphone hole 204 may obtain a sound according to an operation of the camera modules 205, 212, and 213. However, it is not limited thereto.

In an embodiment, the speaker hole 207 may include the external speaker hole 207 and a receiver hole for call (not illustrated). The external speaker hole 207 may be formed on a portion of the third surface 200C of the electronic device 200. In an embodiment, the external speaker hole 207 may be integrated into the microphone hole 203, and the speaker hole 207 and the microphone hole 203 may be implemented as one hole. Although not illustrated, the receiver hole for call (not illustrated) may be formed on another portion of the third surface 200C. For example, the receiver hole for call may be formed on an opposite side of the external speaker hole 207 in the third surface 200C. For example, based on the illustration of FIG. 2A, the external speaker hole 207 may be formed on the third surface 200C corresponding to a lower end of the electronic device 200, and the receiver hole for call may be formed on the third surface 200C corresponding to an upper end of the electronic device 200. However, it is not limited thereto, and in another embodiment, the receiver hole for call may also be formed at a position other than the third surface 200C. For example, the receiver hole for call may also be formed by a separated space between the front plate 202 (or the display 201) and the lateral surface bezel structure 218.

In an embodiment, the electronic device 200 may include at least one speaker (not illustrated) (e.g., the sound output module 155 of FIG. 1) configured to output a sound to the outside of the housing through the external speaker hole 207 and/or the receiver hole for call (not illustrated).

In an embodiment, the sensor module (not illustrated) may generate an electrical signal or a data value corresponding to an internal operating state or an external environmental state of the electronic device 200. For example, the sensor module may include at least one of a proximity sensor, a HRM sensor, a fingerprint sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

In an embodiment, the camera modules 205, 212, and 213 may include the first camera module 205 disposed to face the first surface 200A of the electronic device 200, and the second camera module 212 disposed to face the second surface 200B, and the flash 213.

In an embodiment, the second camera module 212 may include one or more camera modules. The one or more camera modules may include one or more cameras, respectively.

In an embodiment, the first camera module 205 and the second camera module 212 may include one or a plurality of lenses, an image sensor, and/or an image signal processor.

In an embodiment, the flash 213 may include, for example, a light emitting diode or a xenon lamp. In an embodiment, two or more lenses (an infrared camera and a wide-angle and telephoto lens) and image sensors may be disposed on a surface of the electronic device 200.

In an embodiment, the key input device 217 may be disposed on the third surface 200C of the electronic device 200. In an embodiment, the electronic device 200 may not include a portion or all of the key input device 217, and the key input device 217 that is not included may be implemented in another form such as a soft key on the display 201.

In an embodiment, the connector hole 208 may be formed on the third surface 200C of the electronic device 200 such that a connector of an external device may be accommodated. A connecting terminal (e.g., the connecting terminal 178 of FIG. 1) electrically connected to the connector of the external device may be disposed in the connector hole 208. According to an embodiment, the electronic device 200 may include an interface module (e.g., the interface 177 of FIG. 1) for processing an electrical signal transmitted and received through the connecting terminal.

In an embodiment, the electronic device 200 may include the light emitting element (not illustrated). For example, the light emitting element (not illustrated) may be disposed on the first surface 200A of the housing. The light emitting element (not illustrated) may provide state information of the electronic device 200 in an optical form. In an embodiment, the light emitting element (not illustrated) may provide a light source linked with an operation of the first camera module 205. For example, the light emitting element (not illustrated) may include an LED, an IR LED, and/or a xenon lamp.

FIG. 2B is an exploded perspective view of an electronic device according to an embodiment of the disclosure.

Referring to FIG. 2B, according to an embodiment, the electronic device 200 may include a frame structure 240 (e.g., the lateral surface bezel structure 218 of FIG. 2A), a first printed circuit board 280, a second printed circuit board 282, a non-conductive plate 250, and a battery 270 (e.g., the battery 189 of FIG. 1).

In an embodiment, the frame structure (or the frame) 240 may be disposed between the display 201 and the rear plate 211. In an embodiment, the frame structure 240 may support or accommodate components included in the electronic device 200. For example, the display 201 may be disposed on a surface of the frame structure 240 facing in a direction (e.g., a +Z direction). For example, the frame structure 240 may support the front plate 202 to which the display 201 is attached. For example, the first printed circuit board 280, the second printed circuit board 282, the battery 270, and the second camera module 212 may be disposed on another surface facing an opposite direction (e.g., a −Z direction) to the direction of the frame structure 240. The first printed circuit board 280, the second printed circuit board 282, the battery 270, and the second camera module 212 may be disposed in a recess formed in the frame structure 240.

In an embodiment, the frame structure 240 may include a first part 241 and a second part 243. A periphery portion of the second part 243 may be surrounded by the first part 241. The first part 241 may surround a space between the rear plate 211 and the front plate 202 (and/or the display 201). The first part 241 surrounding the space may at least partially form a lateral surface (e.g., the third surface 200C of FIG. 2A) of the electronic device 200, and the second part 243 positioned in the space may extend inward from the first part 241. The second part 243 may be positioned below the display 201 (e.g., in the −Z direction). In an embodiment, the first part 241 and/or the second part 243 may be formed of metal and/or polymer. For a non-limiting example, the first part 241 and the second part 243 may be integrally formed. For example, a metal portion of the first part 241 may be integrally formed with a metal portion of the second part 243. For example, a polymer portion of the first part 241 may be integrally formed with a polymer portion of the second part 243.

The frame structure 240 (or the first part 241 of the frame structure 240) may be referred to as a lateral member or a lateral structure in terms of forming the lateral surface of the electronic device 200. The frame structure 240 (or the second part 243 of the frame structure 240) may be referred to as a support member, a support structure, or a bracket in terms of supporting various components of the electronic device 200.

In an embodiment, the first printed circuit board 280, the second printed circuit board 282, and the battery 270 may be coupled with the frame structure 240, respectively. For example, the first printed circuit board 280 and the second printed circuit board 282 may be fixedly disposed in the frame structure 240 through a coupling member such as a screw. For example, the battery 270 may be fixedly disposed in the frame structure 240 through an adhesive member (e.g., a double-sided tape). However, it is not limited by the above-described example.

In an embodiment, the display 201 may be disposed between the frame structure 240 and the front plate 202. For example, the front plate 202 may be disposed on a side of the display 201 (e.g., in the +Z direction), and the frame structure 240 may be disposed on another side (e.g., in the −Z direction).

In an embodiment, the front plate 202 may be coupled with the display 201. For example, the display 201 may be attached to a back surface of the front plate 202 through an optical adhesive member (e.g., optically clear adhesive (OCA) or optically clear resin (OCR)). In that the front plate 202 is coupled to the display 201, the front plate 202 may be described as being included in the display 201.

In an embodiment, the front plate 202 may be coupled with the frame structure 240. For example, the front plate 202 may include an outer portion extending outward from the display 201 when viewed in a z-axis direction. The outer portion of the front plate 202 may be attached to the frame structure 240 (e.g., the first part 241).

In an embodiment, a processor (e.g., the processor 120 of FIG. 1), memory (e.g., the memory 130 of FIG. 1), and/or an interface (e.g., the interface 177 of FIG. 1) may be disposed on the first printed circuit board 280 and/or the second printed circuit board 282. For example, the processor may include one or more of a central processing unit, an application processor, a graphics processing unit, an image signal processor, a sensor hub processor, or a communication processor. For example, the memory may include volatile memory or non-volatile memory. For example, the interface may include a high definition multimedia interface (HDMI), a universal serial bus (USB) interface, an SD card interface, and/or an audio interface. The interface may electrically or physically connect the electronic device 200 to an external electronic device, and may include a USB connector, an SD card/multimedia card (MMC) connector, or an audio connector. In an embodiment, the first printed circuit board 280 and the second printed circuit board 282 may be operatively or electrically connected to each other through a connecting member (e.g., a flexible printed circuit board).

In an embodiment, the battery 270 may supply power to at least one component of the electronic device 200. For example, the battery 270 may include a rechargeable secondary battery or a fuel cell.

In an embodiment, the first camera module 205 (e.g., a front camera) may be disposed in at least a portion (e.g., the second part 243) of the frame structure 240 such that a lens may receive external light through a partial region (e.g., a camera region 237) of the front plate 202 (e.g., the first surface 200A of FIG. 1).

In an embodiment, the second camera module 212 (e.g., a rear camera) may be disposed between the frame structure 240 and the rear plate 211. In an embodiment, the second camera module 212 may be electrically connected to the first printed circuit board 280 through the connecting member (e.g., the connector). In an embodiment, the second camera module 212 may be disposed such that a lens may receive external light through a camera region 284 of the rear plate 211 of the electronic device 200.

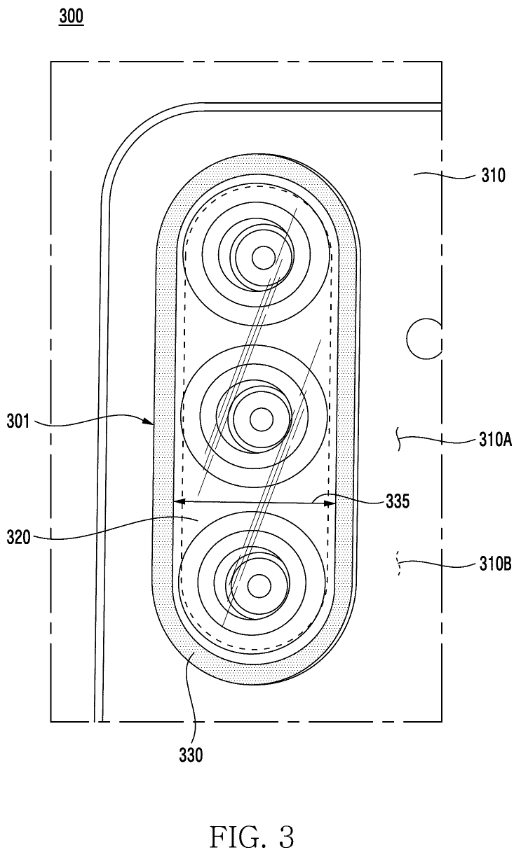

In an embodiment, the camera region 284 may be formed on a surface (e.g., the second surface 200B of FIG. 1) of the rear plate 211. In an embodiment, the camera region 284 may be at least partially transparently formed such that the external light may be incident on the lens of the second camera module 212. The camera region 284 may be defined (or formed) by a camera decoration member (hereinafter referred to as camera deco) (e.g., a camera deco 301 of FIG. 3A) to be described later.

In an embodiment, the housing 210 of the electronic device 200 may mean a configuration or a structure forming at least a portion of the exterior of the electronic device 200. In other words, the housing 210 may include at least a portion of the front plate 202, the frame structure 240, and/or the rear plate 211 forming the exterior of the electronic device 200.

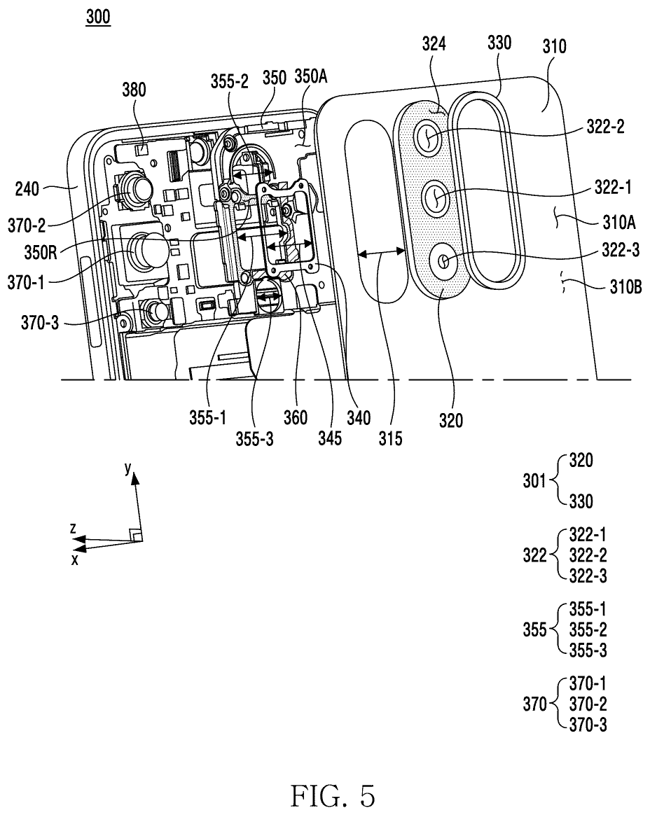

In an embodiment, the non-conductive plate 250 (hereinafter, the plate 250) may be disposed below the rear plate 211 (e.g., in +Z direction). For example, the plate 250 may be disposed between the rear plate 211 and the first printed circuit board 280. In an embodiment, the plate 250 may cover at least a portion of the first printed circuit board 280. The plate 250 may protect the first printed circuit board 280 and components mounted thereon. In an embodiment, the plate 250 may be formed of a non-conductive material (e.g., plastic). A conductive pattern (e.g., a conductive pattern 360 of FIG. 5) may be formed on the plate 250.

Although the bar-type electronic device 200 is exemplified in FIGS. 2A and 2B, a shape or a form factor of the electronic device 200 is not limited by the illustrated example.

For example, a housing of the electronic device 200 may be formed to be deformable. For example, the electronic device 200 may further include a second housing that is movably coupled to a first housing (e.g., the first housing 210) (e.g., linear movement and/or rotation). For example, the second housing may be configured to be rotatable with respect to the first housing through a hinge mechanism (or a hinge structure). The first housing and the second housing may be folded or unfolded by a rotation operation of the second housing with respect to the first housing. In this case, the display 201 of the electronic device 200 may be disposed across the first housing 210 and the second housing. In addition, the display 201 of the electronic device 200 may include a flexible display configured to be deformed according to a folding operation of the first housing and the second housing.

Additionally, the electronic device 200 may further include a third housing that is movably coupled to the first housing or the second housing. For example, the third housing may be rotatably coupled to the first housing (e.g., to an opposite side of the second housing) through the hinge mechanism (or the hinge structure). For another example, the third housing may be rotatably coupled to the second housing through the hinge mechanism (or the hinge structure). As described above, the electronic device 200 including a plurality of housings movably coupled to each other may be referred to as a foldable electronic device or a multi-foldable electronic device.

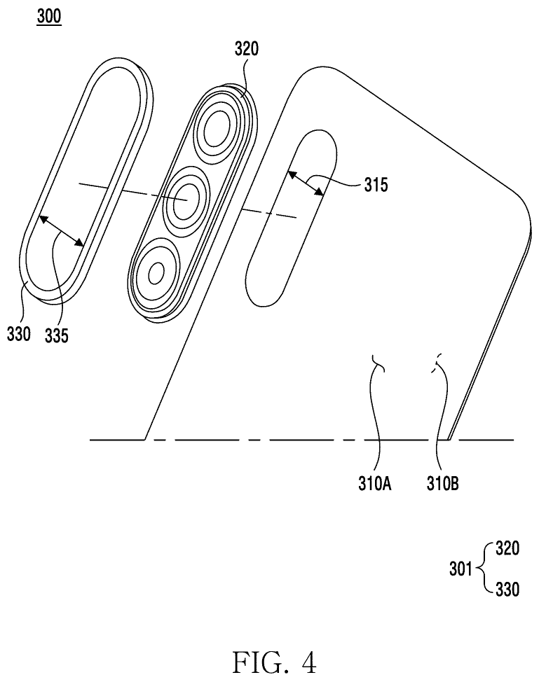

FIGS. 3 and 4 are diagrams indicating a rear surface of an electronic device, according to various embodiments of the disclosure.

Referring to FIGS. 3 and 4, according to an embodiment, an electronic device 300 (e.g., the electronic device 200) may include a non-conductive rear cover 310 (e.g., the rear plate 211) and a camera deco 301 disposed on the non-conductive rear cover 310.

In an embodiment, the non-conductive rear cover 310 (hereinafter, the rear cover 310) may be formed of a non-conductive material. For example, the rear cover 310 may be formed of plastic, glass, ceramic, or a combination thereof.

In an embodiment, the rear cover 310 may form at least a portion of a housing (e.g., the housing 210 of FIG. 2A) or an exterior of the electronic device 300. For example, the rear cover 310 may form (or define) at least a portion of a rear exterior (e.g., the second surface 200B) of the electronic device 300.

In an embodiment, the rear cover 310 may include a first surface 310A and a second surface 310B opposite to the first surface 310A. The first surface 310A may face the outside of the electronic device 300, and the second surface 310B may face the inside of the electronic device 300. For example, the first surface 310A of the rear cover 310 may form (or define) the at least a portion of the rear exterior of the electronic device 300.

In an embodiment, the rear cover 310 may include an opening 315. The opening 315 may penetrate the rear cover 310. For example, the opening 315 may extend from the first surface 310A of the rear cover 310 to the second surface 310B.

In an embodiment, the camera deco 301 may include a non-conductive camera cover 320 and a conductive ring 330. The camera deco 301 may be described as a camera cover, a camera protective member, or a camera cover assembly. The non-conductive camera cover 320 may be described as a deco cover, a camera deco cover, a decoration cover, a decoration member, or a molded cover. The conductive ring 330 may be described as a protective member, a decor ring, a camera deco ring, a decoration ring or a decoration member.

In an embodiment, the non-conductive camera cover 320 (hereinafter, the camera cover 320) may be formed of a non-conductive material. For a non-limiting example, the non-conductive camera cover 320 may be formed of glass, sapphire glass, plastic, or a combination thereof.

In an embodiment, the camera cover 320 may be disposed on the rear cover 310. For example, the camera cover 320 may be disposed on the first surface 310A of the rear cover 310. For example, the camera cover 320 may be disposed on the first surface 310A of the rear cover 310 to cover the opening 315 of the rear cover 310. For example, the camera cover 320 may be attached to the first surface 310A of the rear cover 310 (e.g., through an adhesive material such as a double-sided tape).

For a non-limiting example, the camera cover 320 may include a first part formed of a first non-conductive material (e.g., plastic) and a second part formed of a second non-conductive material (e.g., glass). For example, the first part of the camera cover 320 may be disposed on the rear cover 310 to cover the opening 315 of the rear cover 310. For example, the second part of the camera cover 320 may define one or more window portions (e.g., window portions 322) for cameras. The first part of the camera cover 320 may include one or more openings aligned with the one or more window portions of the second part of the camera cover 320. The second part of the camera cover 320 may be supported by the first part of the camera cover 320. For example, the second part of the camera cover 320 may be disposed on the first part of the camera cover 320 to cover the one or more openings of the first part of the camera cover 320 or may be disposed in the one or more openings of the first part of the camera cover 320.

In an embodiment, the conductive ring 330 may be disposed on the first surface 310A of the rear cover 310. For example, the conductive ring 330 may be disposed on the first surface 310A of the rear cover 310 to surround a periphery of the camera cover 320. For example, the conductive ring 330 may surround all or a portion of the periphery of the camera cover 320 (e.g., the first part and/or the second part of the camera cover 320). In FIG. 3, the conductive ring 330 surrounding the entire periphery of the camera cover 320 is exemplified. For example, the conductive ring 330 may be attached to the periphery of the camera cover 320 (e.g., through an adhesive material such as a double-sided tape). Additionally, the conductive ring 330 may be attached to the first surface 310A of the rear cover 310 (e.g., through the adhesive material such as the double-sided tape). Through an opening 335 of the conductive ring 330, a portion of the camera cover 320 may be visible (or exposed) from the outside of the electronic device 300.

In an embodiment, the conductive ring 330 may be formed of a conductive material. For example, the conductive ring 330 may be formed of a metal. Accordingly, rigidity of the camera deco 301 may be improved. The conductive ring 330 may form an exterior (e.g., the rear exterior) of the electronic device 300 together with the first surface 310A of the rear cover 310 and the camera cover 320. The conductive ring 330 formed of metal may provide a metal-specific visual characteristic (e.g., a texture, a color, and a reflective characteristic) to the exterior of the electronic device 300. In addition, since a visual characteristic of the conductive ring 330 and a visual characteristic of the rear cover 310 and the camera cover 320 are different, a visual contrast effect may be provided to the exterior of the electronic device 300.

However, an electrostatic discharge (ESD) may occur due to the conductive ring 330 exposed to the exterior of the electronic device 300. Due to the ESD, a component inside the electronic device 300 may malfunction or be damaged. For example, due to the ESD, cameras (e.g., one or more cameras 370 of FIG. 5) positioned below the camera deco 301 may be reset or damaged, which may reduce a photographing function of the electronic device 300.

Hereinafter, an ESD discharge structure of the electronic device 300 for solving an ESD problem that may be induced by the conductive ring 330 will be described.

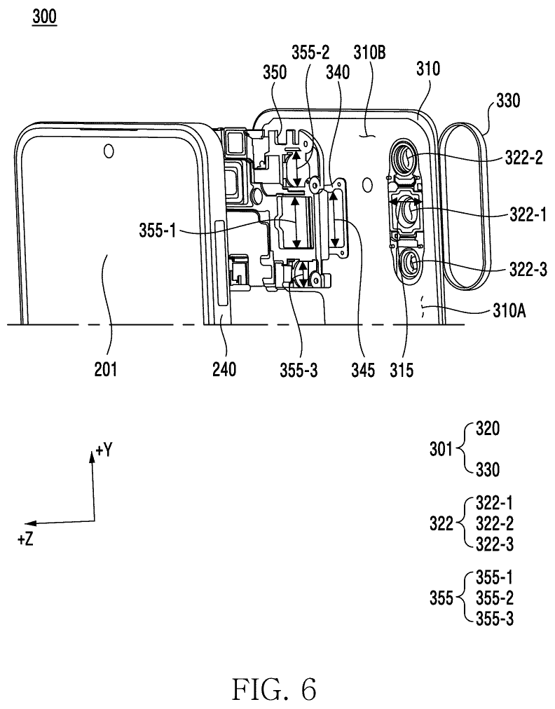

FIGS. 5 and 6 are exploded perspective views of an electronic device, according to various embodiments of the disclosure.

Referring to FIG. 5, in an embodiment, an electronic device 300 may include one or more cameras 370 (e.g., the camera module 180), a printed circuit board 380 (e.g., the first printed circuit board 280), and a conductive pattern 360.

Referring to FIGS. 5 and 6, according to an embodiment, the electronic device 300 may include a conductive frame 340 and a non-conductive plate 350 (e.g., the plate 250).

Referring to FIG. 5, in an embodiment, the printed circuit board 380 and the one or more cameras 370 may be disposed on a frame structure 240 (e.g., the second part 243). For example, the printed circuit board 380 may be disposed below the non-conductive plate 350 (e.g., in a +Z direction). For example, the one or more cameras 370 may be disposed below a camera cover 320 (e.g., in the +Z direction). The one or more cameras 370 may be adjacent to a periphery of the printed circuit board 380.

In an embodiment, the one or more cameras 370 may face a rear direction (e.g., a −Z direction) of the electronic device 300. For example, the one or more cameras 370 may be configured to obtain an image corresponding to the rear direction of the electronic device 300 through a camera deco 301 (e.g., a camera cover 320).

In an embodiment, the one or more cameras 370 may include a first camera 370-1. The one or more cameras 370 may further include, for example, a second camera 370-2 and/or a third camera 370-3. For a non-limiting example, the first camera 370-1, the second camera 370-2, and the third camera 370-3 may be arranged along a direction (e.g., a Y-axis direction). For a non-limiting example, the first camera 370-1 may be disposed between the second camera 370-2 and the third camera 370-3. The first camera 370-1 may be a main camera (and/or a basic camera) of the one or more cameras 370. For a non-limiting example, the first camera 370-1 may include a wide-angle camera, the second camera 370-2 may include an ultra-wide-angle camera, and the third camera 370-3 may include a telephoto camera. In an embodiment, the first camera 370-1, the second camera 370-2, and the third camera 370-3 may be included, respectively, in camera modules that are distinct from each other. Alternatively, the first camera 370-1, the second camera 370-2, and the third camera 370-3 may be included in one camera module (e.g., the second camera module 212).

In an embodiment, the camera cover 320 may include one or more window portions 322 (or one or more camera window portions 322) for the one or more cameras 370 and a region 324 (or a portion 324) surrounding the one or more window portions 322. The one or more window portions 322 may be formed to be substantially transparent, and the region 324 may be formed to be substantially opaque. The one or more cameras 370 may be configured to receive light through the one or more window portions 322 of the camera cover 320.

In an embodiment, the one or more window portions 322 of the camera cover 320 may include a first window portion 322-1 corresponding to the first camera 370-1. For example, the first window portion 322-1 may be aligned with the first camera 370-1. For example, the first window portion 322-1 may be disposed above the first camera 370-1 (e.g., in the −Z direction). For example, the first window portion 322-1 may be substantially centered on an optical axis of the first camera 370-1.

In an embodiment, the one or more window portions 322 may further include a second window portion 322-2 corresponding to the second camera 370-2 and/or a third window portion 322-3 corresponding to the third camera 370-3. For example, the second window portion 322-2 may be aligned with the second camera 370-2. For example, the second window portion 322-2 may be disposed above the second camera 370-2 (e.g., in the −Z direction). For example, the second window portion 322-2 may be substantially centered on an optical axis of the second camera 370-2. For example, the third window portion 322-3 may be aligned with the third camera 370-3. For example, the third window portion 322-3 may be disposed above the third camera 370-3 (e.g., in the −Z direction). For example, the third window portion 322-3 may be substantially centered on an optical axis of the third camera 370-3.

Referring to FIGS. 5 and 6, in an embodiment, the conductive frame 340 may be formed of a conductive material. For example, the conductive frame 340 may be formed of metal. For a non-limiting example, the conductive frame 340 may be formed of stainless steel.

In an embodiment, the conductive frame 340 may be disposed between a rear cover 310 and the non-conductive plate 350. For example, the conductive frame 340 may be disposed below the rear cover 310 (e.g., in the +Z direction). For example, the conductive frame 340 may be disposed on a second surface 310B of the rear cover 310. For example, the conductive frame 340 may be detached from the second surface 310B of the rear cover 310. For example, the conductive frame 340 may not be attached to the second surface 310B of the rear cover 310. Alternatively, the conductive frame 340 may be attached to the second surface 310B of the rear cover 310 (e.g., through an adhesive material such as a double-sided tape).

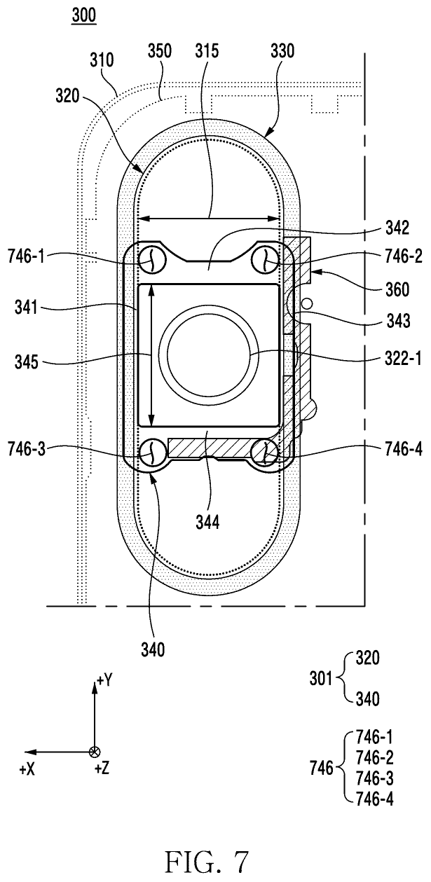

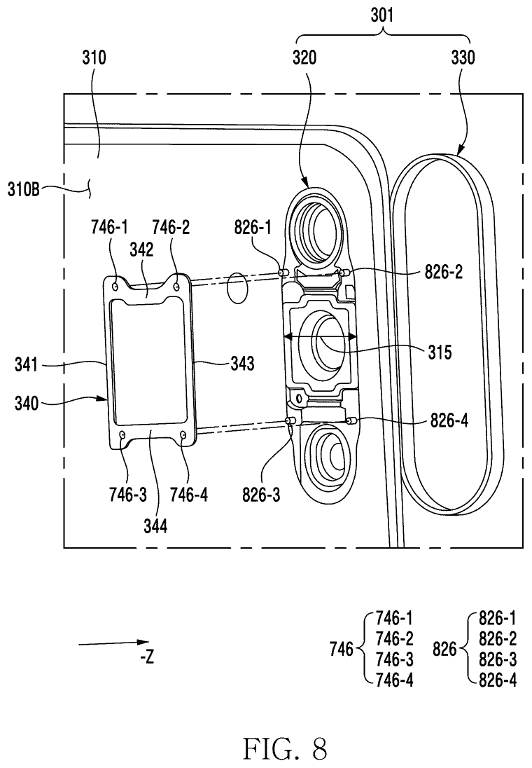

In an embodiment, the conductive frame 340 may be configured to fix the camera cover 320 to the rear cover 310. In an embodiment, the conductive frame 340 may be disposed on the second surface 310B of the rear cover 310 to overlap at least a portion of a conductive ring 330. For example, the conductive frame 340 may face the at least a portion of the conductive ring 330 through the rear cover 310. For example, the conductive frame 340 and the at least a portion of the conductive ring 330 may face each other with the rear cover 310 interposed therebetween. In addition, the conductive frame 340 may be coupled to the camera cover 320. For example, the conductive frame 340 may include one or more first portions (e.g., a first portion 341 and/or a third portion 343 of FIG. 7) disposed on the second surface 310B of the rear cover 310, and one or more second portions (e.g., a second portion 342 and/or a fourth portion 344) extending from the one or more first portions to cross an opening 315 of the rear cover 310. The one or more first portions of the conductive frame 340 may overlap the at least a portion of the conductive ring 330, and the one or more second portions of the conductive frame 340 may be coupled to the camera cover 320. A coupling structure of the conductive frame 340 and the camera cover 320 will be described in detail with reference to FIG. 8.

In an embodiment, as the conductive frame 340 overlaps the at least a portion of the conductive ring 330, the conductive frame 340 and the conductive ring 330 may be electrically coupled.

In the disclosure, a first component and a second component being “electrically coupled” may mean that they are indirectly electrically connected. For example, the first component and the second component being “electrically coupled” may mean a state in which an electrical signal or power may be mutually transferred, even when the first component and the second component are not directly connected through a conductor. For example, the first component and the second component being “electrically coupled” may mean a state in which an electrical signal or power may be transmitted through an electric field with a dielectric therebetween, that is, may include the first component and the second component being capacitively coupled.

In an embodiment, the non-conductive plate 350 (hereinafter, the plate 350) may be formed of a non-conductive material (e.g., plastic). In an embodiment, the plate 350 may be disposed below the conductive frame 340 (e.g., in the +Z direction). For example, referring to FIG. 5, the plate 350 may be disposed between the conductive frame 340 and the printed circuit board 380. In an embodiment, the plate 350 may cover at least a portion of the printed circuit board 380, and may also include one or more openings 355 for the one or more cameras 370. For example, the plate 350 may include a first portion covering the printed circuit board 380 (e.g., overlapping the printed circuit board 380) and a second portion extending from the first portion of the plate 350 in an outward direction (e.g., a +X direction) of the printed circuit board 380 and including the one or more openings 355.

In an embodiment, the one or more openings 355 of the plate 350 may include a first opening 355-1 accommodating the first camera 370-1. For example, a portion of the first camera 370-1 may be disposed in the first opening 355-1. The one or more openings 355 may further include a second opening 355-2 accommodating the second camera 370-2 and/or a third opening 355-3 accommodating the third camera 370-3. For example, a portion of the second camera 370-2 may be disposed in the second opening 355-2. For example, a portion of the third camera 370-3 may be disposed in the third opening 355-3.

In an embodiment, the plate 350 may include a first surface 350A facing the conductive frame 340 (or the rear cover 310) (e.g., in the −Z direction). In addition, the plate 350 may include a recessed region 350R formed on the first surface 350A. For example, the recessed region 350R may be formed along a periphery of the first opening 355-1 of the plate 350. For a non-limiting example, a portion of the recessed region 350R may be formed between the first opening 355-1 and the second opening 355-2. For a non-limiting example, another portion of the recessed region 350R may be formed between the first opening 355-1 and the third opening 355-3.

In an embodiment, the conductive pattern 360 may be formed on the plate 350. For example, the conductive pattern 360 may be formed on the first surface 350A of the plate 350. For example, the conductive pattern 360 may be formed on the recessed region 350R formed on the first surface 350A of the plate 350. For example, the conductive pattern 360 may be formed on the plate 350 using laser direct structuring (LDS). In this respect, the conductive pattern 360 may be described as an LDS pattern.

In an embodiment, the conductive pattern 360 may overlap at least a portion of the conductive frame 340 and may be spaced apart from the conductive frame 340. A dielectric (e.g., air) may be disposed between the conductive pattern 360 and the conductive frame 340. For example, the conductive pattern 360 may face the at least the portion of the conductive frame 340 through the dielectric. As the conductive pattern 360 and the conductive frame 340 face each other with the dielectric therebetween, the conductive pattern 360 may be electrically coupled to the conductive frame 340. Alternatively, the conductive pattern 360 may be directly electrically connected to the conductive frame 340 or may be electrically connected to the conductive frame 340 through another conductor.

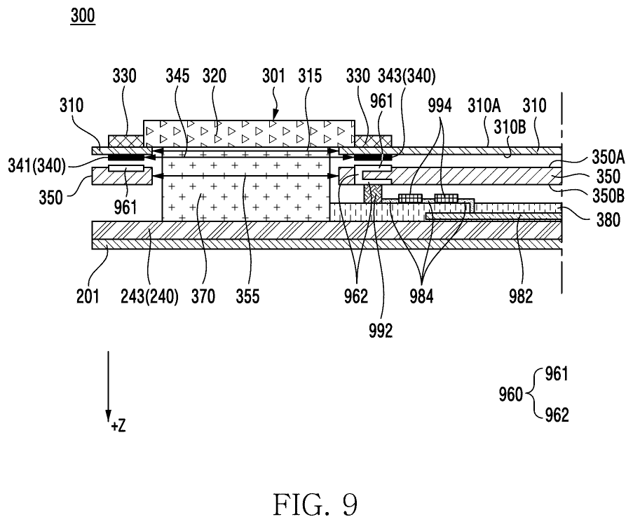

In an embodiment, the conductive pattern 360 may be electrically connected to a ground of the electronic device 300. For example, the conductive pattern 360 may be electrically connected to a conductive region (e.g., a conductive region 982 of FIG. 9) of the printed circuit board 380 functioning at least partially as the ground. An electrical connection structure related to the conductive pattern 360 will be described in detail with reference to FIG. 8.

In an embodiment, the conductive ring 330 may be electrically connected to the ground of the electronic device 300. For example, the conductive ring 330 may be electrically connected to the ground of the electronic device 300 through the conductive frame 340 electrically coupled to the conductive ring 330 and the conductive pattern 360 electrically coupled to the conductive frame 340. As described above, an electrical path through which the conductive ring 330 is connected to the ground of the electronic device 300 may form an ESD discharge path. For example, an ESD generated and/or induced by the conductive ring 330 may be discharged to the ground of the electronic device 300 through the conductive frame 340 electrically coupled to the conductive ring 330 and the conductive pattern 360 electrically coupled to the conductive frame 340. Accordingly, damage and/or malfunction of components (e.g., the one or more cameras 370) of the electronic device 300 due to the ESD may be reduced and/or prevented.

FIG. 7 is a transparency diagram indicating a camera region of an electronic device, according to an embodiment of the disclosure. FIG. 7 is illustrated in a form projected on the same plane so that an overlapping region between components appears.

Referring to FIG. 7, according to an embodiment, a conductive frame 340 may include a first portion 341, a second portion 342, a third portion 343, and a fourth portion 344.

In an embodiment, the third portion 343 of the conductive frame 340 may be opposite to the first portion 341 of the conductive frame 340. For example, when a rear cover 310 is viewed from above (e.g., when viewed in a Z-axis direction), the third portion 343 of the conductive frame 340 may be opposite to the first portion 341 of the conductive frame 340 with an opening 315 of the rear cover 310 interposed therebetween. Each of the first portion 341 and the third portion 343 of the conductive frame 340 may extend along a periphery of the opening 315 of the rear cover 310.

In an embodiment, each of the second portion 342 and the fourth portion 344 of the conductive frame 340 may extend from the first portion 341 to the third portion 343 to cross the opening 315 of the rear cover 310. The second portion 342 and the fourth portion 344 of the conductive frame 340 may be spaced apart from each other. The second portion 342 and the fourth portion 344 of the conductive frame 340 may face a camera cover 320 through the opening 315 of the rear cover 310. When viewed from above (e.g., when viewed in the Z-axis direction), a first window portion 322-1 of the camera cover 320 may be positioned between the second portion 342 and the fourth portion 344 of the conductive frame 340.

In an embodiment, the first portion 341, the second portion 342, the third portion 343, and the fourth portion 344 of the conductive frame 340 may define an opening 345 of the conductive frame 340. The opening 345 of the conductive frame 340 may be aligned with the first window portion 322-1 of the camera cover 320. For example, the opening 345 of the conductive frame 340 may be aligned with the first window portion 322-1 of the camera cover 320 in a vertical direction (e.g., a Z-axis). For example, the opening 345 of the conductive frame 340 may be substantially centered with the first window portion 322-1 of the camera cover 320 in the vertical direction.

In an embodiment, the first portion 341 and the third portion 343 of the conductive frame 340 may overlap a conductive ring 330. For example, the conductive ring 330 may include an upper portion, a lower portion, and a central portion between them based on a direction (e.g., a Y-axis). The upper portion, the lower portion, and the central portion of the conductive ring 330 may surround a periphery of an upper portion, a periphery of a lower portion, and a periphery of a central portion therebetween of the camera cover 320, respectively. In an embodiment, the first portion 341 and the third portion 343 of the conductive frame 340 may overlap the central portion of the conductive ring 330.

In an embodiment, one or more holes 746 overlapping the opening 315 of the rear cover 310 and the camera cover 320 may be formed in the conductive frame 340. For example, the one or more holes 746 may include at least one of a first hole 746-1, a second hole 746-2, a third hole 746-3, and a fourth hole 746-4.

For example, the first hole 746-1 and the second hole 746-2 may be formed in the second portion 342 of the conductive frame 340. For example, the first hole 746-1 may be adjacent to the first portion 341 of the conductive frame 340, and the second hole 746-2 may be adjacent to the third portion 343 of the conductive frame 340.

For example, the third hole 746-3 and the fourth hole 746-4 may be formed in the fourth portion 344 of the conductive frame 340. For example, the third hole 746-3 may be adjacent to the first portion 341 of the conductive frame 340, and the fourth hole 746-4 may be adjacent to the third portion 343 of the conductive frame 340.

FIG. 8 indicates a coupling structure between a camera cover and a conductive frame, according to an embodiment of the disclosure.

Referring to FIG. 8, according to an embodiment, a camera cover 320 may include one or more protrusions 826 respectively corresponding to one or more holes 746 of a conductive frame 340. The one or more protrusions 826 may be coupled to a conductive frame 340.

For example, the one or more protrusions 826 may include at least one of a first protrusion 826-1, a second protrusion 826-2, a third protrusion 826-3, and a fourth protrusion 826-4.

For example, the first protrusion 826-1 of the camera cover 320 may correspond to a first hole 746-1 of the conductive frame 340. For example, the first protrusion 826-1 of the camera cover 320 may penetrate the first hole 746-1 of the conductive frame 340. For example, at least a portion of the first protrusion 826-1 of the camera cover 320 may be disposed in the first hole 746-1 of the conductive frame 340.

For example, the second protrusion 826-2 of the camera cover 320 may correspond to a second hole 746-2 of the conductive frame 340. For example, the second protrusion 826-2 of the camera cover 320 may penetrate the second hole 746-2 of the conductive frame 340. For example, at least a portion of the second protrusion 826-2 of the camera cover 320 may be disposed in the second hole 746-2 of the conductive frame 340.

For example, the third protrusion 826-3 of the camera cover 320 may correspond to a third hole 746-3 of the conductive frame 340. For example, the third protrusion 826-3 of the camera cover 320 may penetrate the third hole 746-3 of the conductive frame 340. For example, at least a portion of the third protrusion 826-3 of the camera cover 320 may be disposed in the third hole 746-3 of the conductive frame 340.

For example, the fourth protrusion 826-4 of the camera cover 320 may correspond to a fourth hole 746-4 of the conductive frame 340. For example, the fourth protrusion 826-4 of the camera cover 320 may penetrate the fourth hole 746-4 of the conductive frame 340. For example, at least a portion of the fourth protrusion 826-4 of the camera cover 320 may be disposed in the fourth hole 746-4 of the conductive frame 340.

According to an embodiment, the conductive frame 340 may be coupled to the camera cover 320. For example, as a second portion 342 and a fourth portion 344 of the conductive frame 340 are couple to the one or more protrusions 826 of the camera cover 320, the conductive frame 340 may be coupled to the camera cover 320. For example, as the one or more protrusions 826 of the camera cover 320 in a state of being fastened to the one or more holes 746 of the conductive frame 340 are fused to the conductive frame 340, the conductive frame 340 and the camera cover 320 may be coupled. In addition, a first portion 341 and a third portion 343 of the conductive frame 340 may be positioned on a second surface 310B of the rear cover 310 outside an opening 315 of the rear cover 310. As the conductive frame 340 includes a portion (e.g., the second portion 342 and the fourth portion 344) coupled to the camera cover 320 through the opening 315 of the rear cover 310 and another portion (e.g., the first portion 341 and the third portion 343) configured to be caught by the second surface 310B of the rear cover 310 on both sides of the opening 315 of the rear cover 310, a camera deco 301 may not be detached from the rear cover 310 (e.g., in a −Z direction).

Additionally, the second portion 342 and the fourth portion 344 of the conductive frame 340 may be attached to the camera cover 320 through an adhesive material such as a double-sided tape (e.g., before the fusion).

FIG. 9 is a cross-sectional view of an electronic device, according to an embodiment of the disclosure.

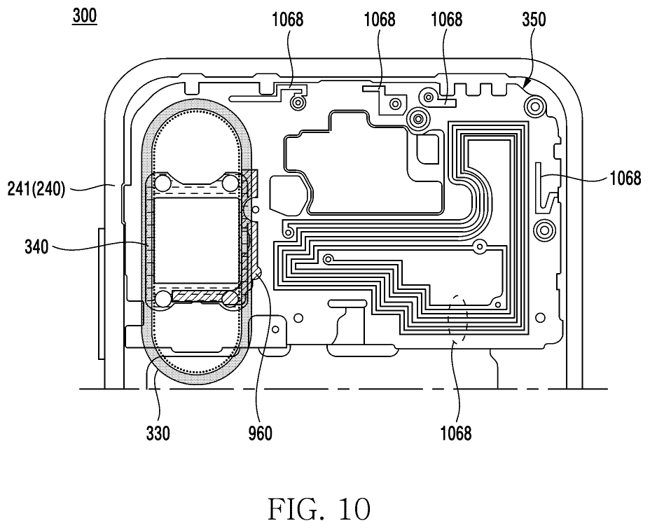

FIG. 10 is a planar view of an electronic device, according to an embodiment of the disclosure. FIG. 10 is illustrated in a form projected on the same plane such that an overlapping region between components appears.

Referring to FIG. 9, in an embodiment, a printed circuit board 380 may include a conductive region 982 that functions at least partially as the ground of an electronic device 300. The conductive region 982 may be referred to as a ground, a ground region, or a ground plane of the printed circuit board 380.

According to an embodiment, the electronic device 300 may include a connector 992 disposed on the printed circuit board 380. For a non-limiting example, the connector 992 may include an elastic connector (or a spring connector) such as a C-clip or a conductive gasket.

According to an embodiment, the electronic device 300 may include a conductive pattern 960 (e.g., the conductive pattern 360 of FIG. 5). At least a portion of the conductive pattern 960 may include a first portion 961 (e.g., the conductive pattern 360) formed on a plate 350 (e.g., a first surface 350A) and a second portion 962 electrically connecting (and/or for electrically connecting) the first portion 961 to the ground of the electronic device 300, in order to overlap a conductive frame 340.

For example, the second portion 962 of the conductive pattern 960 may extend from the first portion 961 to the connector 992 disposed on the printed circuit board 380. For example, the second portion 962 of the conductive pattern 960 may include a first section extending from the first portion 961 through (e.g., by penetrating) the plate 350 and a second section formed on a second surface 350B (e.g., opposite to the first surface 350A) of the plate 350 to connect the first section to the connector 992. Additionally, the second portion 962 of the conductive pattern 960 may further include a third section extending from the first portion 961 so as not to overlap the conductive frame 340. In this case, the first section of the conductive pattern 960 penetrating the plate 350 may extend from the third section of the conductive pattern 960 other than the first portion 961 of the conductive pattern 960.

In an embodiment, the conductive pattern 960 may be electrically connected to the connector 992. The connector 992 may be electrically connected to the conductive region 982 through an electrical path 984 formed in the printed circuit board 380. Accordingly, the conductive pattern 960 may be electrically connected to the conductive region 982 of the printed circuit board 380. The conductive region 982 may be electrically connected to a conductive portion included in a second part 243 of a frame structure 240. For example, the conductive portion of the second part 243 of the frame structure 240 may function as the ground of the electronic device 300 together with the conductive region 982 of the printed circuit board 380.

According to an embodiment, the electronic device 300 may further include at least one element 994 disposed on the printed circuit board 380. The at least one element 994 may include at least one passive element. For example, the at least one element 994 may include at least one of resistance (R), inductor (L), and/or capacitor (C).

In an embodiment, the conductive pattern 960 may be electrically connected to the conductive region 982 of the printed circuit board 380 through the at least one element 994. For example, the electrical path 984 of the printed circuit board 380 may connect the connector 992 electrically connected to the conductive pattern 960 to the at least one element 994, and may also electrically connect the at least one element 994 to the conductive region 982.

The at least one element 994 may be configured to improve isolation between the conductive ring 330, the conductive frame 340, and the conductive pattern 960 which form an electrical path for ESD discharge and another antenna.

For example, referring to FIG. 10, according to an embodiment, the electronic device 300 may include a plurality of other conductive patterns 1068 formed on the plate 350. The plurality of other conductive patterns 1068 may function at least partially as an antenna (e.g., an antenna radiator) of the electronic device 300. As another example, a conductive portion included in a first part 241 of the frame structure 240 of the electronic device 300 may function at least partially as an antenna (e.g., an antenna radiator) of the electronic device 300.

Referring back to FIG. 9, isolation between the conductive ring 330, the conductive frame 340, and the conductive pattern 960 forming an ESD discharge path and the antennas (e.g., the plurality of other conductive patterns 1068 and the conductive portion of the first part 241) of the electronic device 300 adjacent to the ESD discharge path may be improved by being electrically connected to the conductive region 982 of the printed circuit board 380 through the at least one element 994. Accordingly, when the antennas of the electronic device 300 operate, a correlation due to the conductive ring 330, the conductive frame 340, and the conductive pattern 960 may be reduced.

A camera cover 320 may cover an opening 315 of a rear cover 310. For example, the camera cover 320 may be disposed on a first surface 310A of the rear cover 310 to cover the opening 315 of the rear cover 310. For another example, the camera cover 320 may be at least partially disposed (or inserted) in the opening 315 of the rear cover 310 to cover the opening 315 of the rear cover 310. In this case, the camera cover 320 may also include a portion disposed on the first surface 310A of the rear cover 310, and may also be disposed in the opening of the rear cover 310 without the portion disposed on the first surface 310A of the rear cover 310.

When the camera cover 320 includes the portion disposed in the opening 315 of the rear cover 310, the camera cover 320 may further include a portion extending from the portion disposed in the opening 315 of the rear cover 310 and disposed on a second surface 310B of the rear cover 310. The portion of the camera cover 320 disposed in the opening 315 of the rear cover 310 may be attached to the opening 315 (e.g., an inner surface of the opening 315) of the rear cover 310. In addition, the portion of the camera cover 320 disposed on the second surface 310B of the rear cover 310 may be attached to the second surface 310B of the rear cover 310.

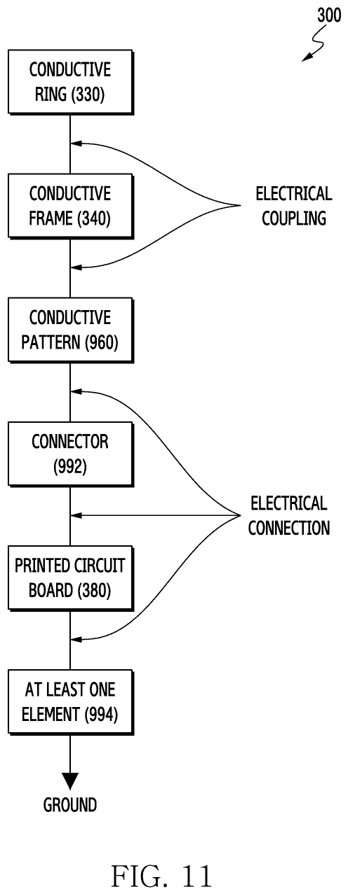

FIG. 11 is a block diagram indicating an ESD discharge path of an electronic device, according to an embodiment of the disclosure.

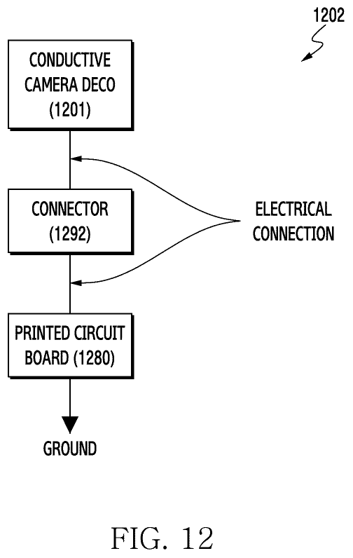

FIG. 12 is a block diagram indicating an ESD discharge path of an electronic device to a comparative example according to an embodiment of the disclosure.

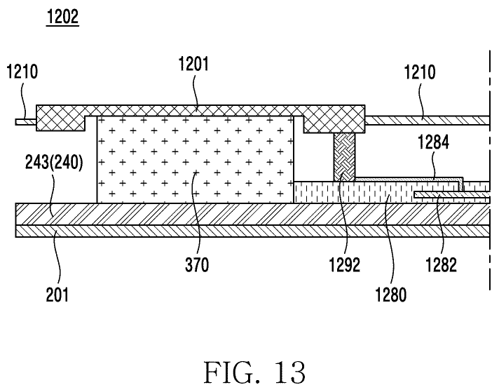

FIG. 13 is a cross-sectional view of an electronic device to a comparative example according to an embodiment of the disclosure.

Referring to FIG. 11, an ESD discharge path of an electronic device 300 may include a conductive ring 330, a conductive frame 340 electrically coupled to the conductive ring 330, a conductive pattern 960 (e.g., the conductive pattern 360 of FIG. 5) electrically coupled to the conductive frame 340, a connector 992 electrically connected to the conductive pattern 960, a printed circuit board 380 (e.g., an electrical path 984) electrically connecting the connector 992 to at least one element 994, and the at least one element 994 electrically connected to a ground (e.g., a conductive region 982 of the printed circuit board 380 and/or a second part 243 of a frame structure 240).

Referring to FIG. 12, an ESD discharge path of an electronic device 1202 according to a comparative example may include a conductive camera deco 1201, a connector 1292 electrically connected to the conductive camera deco 1201, and a printed circuit board 1280 electrically connecting the connector 1292 to a ground.

Referring to FIG. 13, an electronic device 1202 according to a comparative example may include a conductive camera deco 1201 installed on a rear cover 1210 to be positioned above one or more cameras 370. A connector 1292 disposed on a printed circuit board 1280 may be directly electrically connected to the conductive camera deco 1201. An electrical path 1284 of the printed circuit board 1280 may electrically connect the connector 1292 to a conductive region 1282 of the printed circuit board 1280. Accordingly, the ESD discharge path of the comparative example as illustrated in FIG. 12 may be formed.

In an embodiment, in a camera deco 301, a volume ratio occupied by a conductive portion (e.g., a conductive ring 330) may be smaller than a volume ratio occupied by a non-conductive portion (e.g., a camera cover 320). Alternatively, the conductive camera deco 1201 according to the comparative example may be mostly formed of a conductive portion.

Accordingly, in a case of the electronic device 300 according to an embodiment, material costs may be reduced compared to the electronic device 1202 according to the comparative example. In addition, in a case of the electronic device 300 according to an embodiment, performance degradation of antennas of the electronic device 300 due to the conductive portion of the camera deco 301 may be reduced compared to the electronic device 1202 according to the comparative example.

In other words, according to an embodiment, the electronic device 300 may form a discharge path of an ESD that may be caused by the camera deco 301 using an electrical coupling structure, with relatively lower material costs and relatively smaller antenna performance degradation, even when a conductive material (e.g., a conductive ring 330) is used for only a portion of the camera deco 301 for an appearance characteristic. Accordingly, damage and/or malfunction of a component (e.g., one or more cameras 370) of the electronic device 300 due to the ESD may be reduced and/or prevented.

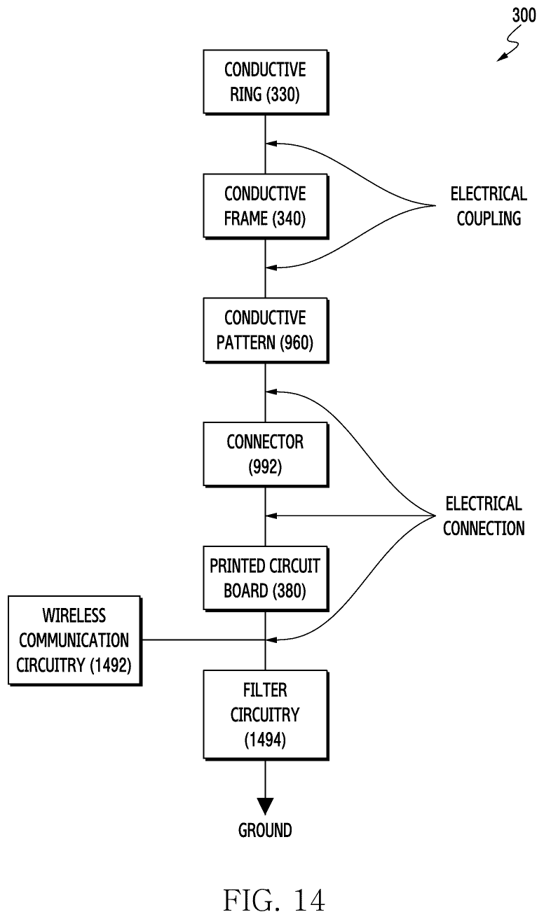

FIG. 14 is a block diagram of an electronic device, according to an embodiment of the disclosure.

Referring to FIG. 14, according to an embodiment, an electronic device 300 may include wireless communication circuitry 1492 (e.g., the wireless communication circuitry 192) and filter circuitry 1494 (or a filter element 1494).

In an embodiment, the wireless communication circuitry 1492 may be electrically connected to a conductive pattern 960 through a connector 992. For example, the wireless communication circuitry 1492 may be disposed on a printed circuit board 380 and may be electrically connected to the connector 992 through an electrical path (e.g., an electrical path 984) formed on the printed circuit board 380.

In an embodiment, the conductive pattern 960 may function at least partially as an antenna (e.g., an antenna radiator) of the electronic device 300. For example, the wireless communication circuitry 1492 may transmit and/or receive an RF signal using the conductive pattern 960. The RF signal may be transmitted through the connector 992 electrically connecting the conductive pattern 960 and the wireless communication circuit 1492, and the electrical path of the printed circuit board 380. Additionally, a conductive frame 340 electrically coupled to the conductive pattern 960 and a conductive ring 330 electrically coupled to the conductive frame 340 may also function at least partially as an antenna (e.g., an antenna radiator) of the electronic device 300, together with the conductive pattern 960.

The filter circuitry 1494 may include at least one element configured to reduce and/or prevent the RF signal from being lost to the ground. Additionally, the filter circuitry 1494 may include a diode-based filter or SAW filter configured to reduce and/or prevent the RF signal from being lost to the ground.

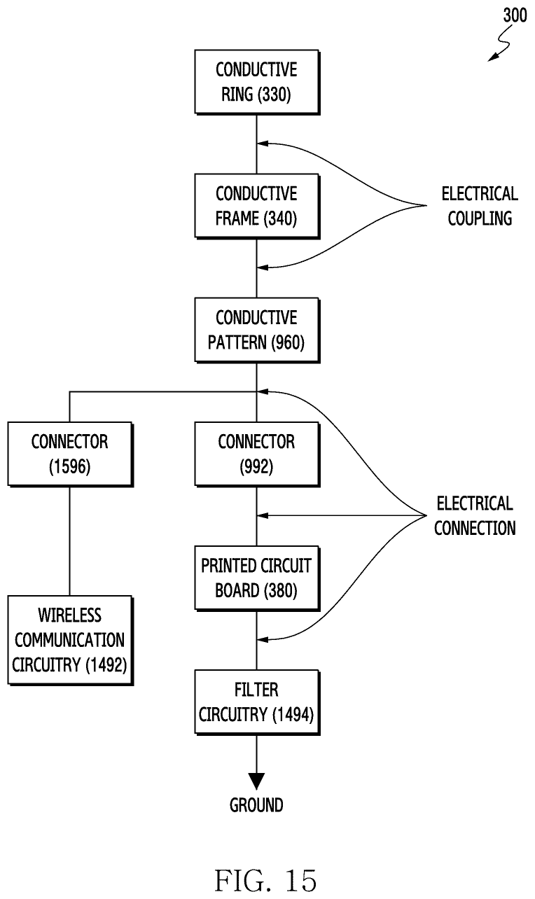

FIG. 15 is a block diagram of an electronic device, according to an embodiment of the disclosure.

Referring to FIG. 15, according to an embodiment, an electronic device 300 may further include a connector 1596. The connector 1596 may be disposed on a printed circuit board 380.

Unlike the wireless communication circuitry 1492 of FIG. 14 is electrically connected to the conductive pattern 960 through the connector 992, the wireless communication circuitry 1492 of FIG. 15 may be electrically connected to the conductive pattern 960 through the connector 1596. Through the connector 1596, the wireless communication circuitry 1492 may transmit the RF signal to the conductive pattern 960 and/or receive the RF signal from the conductive pattern 960.

The technical problems to be achieved in this document are not limited to those described above, and other technical problems not mentioned herein will be clearly understood by those having ordinary knowledge in the art to which the disclosure belongs.

According to an embodiment, an electronic device 300 may comprise a non-conductive rear cover 310, including a first surface 310A defining at least a portion of a rear exterior (i.e., second surface 200B) of the electronic device 300 and a second surface 310B opposite to the first surface 310A, the non-conductive rear cover defining an opening 315, a non-conductive camera cover 320, covering the opening 315 of the non-conductive rear cover 310, including a light transmittance portion 322, a camera 370 disposed below the light transmittance portion 322 of the non-conductive camera cover 320, to be aligned with the light transmittance portion 322 of the non-conductive camera cover 320, a conductive ring 330, attached to the first surface 310A of the non-conductive rear cover 310, surrounding the non-conductive camera cover 320, and a conductive frame 340 configured to fix the non-conductive camera cover 320 to the non-conductive rear cover 310, the conductive frame at least partially overlapping the conductive ring 330 and being spaced apart from the conductive ring 330. The conductive frame 340 may be electrically connected to a ground of the electronic device 300 such that the conductive ring 330 is electrically connected to the ground of the electronic device 300 through an electrical coupling with the conductive frame 340 spaced apart from the conductive ring 330.

In an embodiment, the conductive ring 330 may be electrically connected to the ground of the electronic device 300 to form an electrical path for an electrostatic discharge (ESD).

In an embodiment, the conductive frame 340 may be structurally coupled to the non-conductive camera cover 320.

In an embodiment, the conductive frame 340 may include a first portion 341 overlapping a portion of the conductive ring 330, a second portion overlapping another portion of the conductive ring 330, and a third portion 342 or 344, extending across the opening 315 of the non-conductive camera cover 320 from the first portion 341 of the conductive frame 340 to the second portion of the conductive frame 340. The third portion 342 or 344 of the conductive frame 340 may be structurally coupled to the non-conductive camera cover 320.

In an embodiment, the non-conductive camera cover 320 may include at least one protrusion 826 coupled to the third portion 342 or 344 of the conductive frame 340.

In an embodiment, the at least one protrusion 826 of the non-conductive camera cover 320 may extend through the third portion 342 or 344 of the conductive frame 340 and may be fused to the third portion 342 or 344 of the conductive frame 340.

In an embodiment, the electronic device 300 may further comprise an adhesive material attaching the third portion 342 or 344 of the conductive frame 340 to the non-conductive camera cover 320.

In an embodiment, the electronic device 300 may comprise a non-conductive plate 350 disposed below the conductive frame 340, and a conductive pattern 360 or 960, formed on the non-conductive plate 350, spaced apart from the conductive frame 340, and at least partially overlapping the conductive frame 340. The conductive ring 330 may be electrically connected to the ground of the electronic device 300 through the electrical coupling with the conductive frame 340 spaced apart from the conductive ring 330, and an electrical coupling between the conductive frame 340 and the conductive pattern 360 or 960 spaced apart from the conductive frame 340.

In an embodiment, the non-conductive plate 350 may include a surface 350A facing the conductive frame 340. A recessed region 350R may be formed on the surface 350A of the non-conductive plate 350. At least a portion of the conductive pattern 360 or 960 may be formed on the recessed region 350R of the non-conductive plate 350.

In an embodiment, the electronic device 300 may comprise a printed circuit board 380 including a ground region 982 configured to function at least partially as the ground of the electronic device 300. The conductive pattern 360 or 960 may be electrically connected to the ground region 982 of the printed circuit board 380.

In an embodiment, the electronic device 300 may comprise a conductive connector, disposed on the printed circuit board 380, connecting the conductive pattern 360 or 960 to the ground region of the printed circuit board 380.

In an embodiment, the non-conductive plate 350 may include another surface 350B, opposite to the surface 350A of the non-conductive plate 350, facing the printed circuit board 380. The conductive pattern 360 or 960 may include a first portion 961, formed on the surface 350A of the non-conductive plate 350, a second portion 962, formed on the another surface 350B of the non-conductive plate 350, being in contact with the conductive connector, a third portion extending through the non-conductive plate 350 from the first portion 961 of the conductive pattern 360 or 960 to the second portion 962 of the conductive pattern 360 or 960.

In an embodiment, the non-conductive plate 350 may include an opening portion defining an opening 355 in which a portion of the camera 370 is disposed. At least a portion of the conductive pattern 360 or 960 may be formed on the opening portion of the non-conductive plate 350.

In an embodiment, the conductive pattern 360 or 960 may be used as at least a portion of an antenna of the electronic device 300.

In an embodiment, the electronic device 300 may further comprise another conductive pattern 1068, formed on the non-conductive plate 350, used as at least a portion of another antenna of the electronic device 300.

In an embodiment, the conductive frame 340 may define an opening 345 aligned with the light transmittance portion 322 of the non-conductive camera cover 320. A portion of the camera 370 may be disposed in the opening 345 of the conductive frame 340.

In an embodiment, the conductive ring 330 may be attached to an edge portion of the non-conductive camera cover 320.

According to an embodiment, an electronic device 300 may comprise a non-conductive rear cover 310, including a first surface 310A defining at least a portion of a rear exterior (i.e., second surface 200B) of the electronic device 300 and a second surface 310B opposite to the first surface 310A, the non-conductive rear cover defining an opening 315, a non-conductive camera cover 320, attached to the first surface 310A of the non-conductive rear cover 310 to cover the opening 315 of the non-conductive rear cover 310, the non-conductive camera cover including a light transmittance portion 322, a camera 370, disposed below the light transmittance portion 322 of the non-conductive camera cover 320, configured to receive light through the light transmittance portion 322 of the non-conductive camera cover 320, a conductive protective member disposed on the first surface 310A of the non-conductive rear cover 310, surrounding a periphery portion of the non-conductive camera cover 320, a conductive frame 340, attached to the second surface 310B of the non-conductive rear cover 310 to at least partially overlap the conductive protective member, a non-conductive plate 350, disposed below the conductive frame 340, and a conductive pattern 360 or 960, formed on the non-conductive plate 350, spaced apart from the conductive frame 340, and at least partially overlapping the conductive frame 340. The conductive protective member may be electrically connected to a ground of the electronic device 300 through the conductive frame 340, spaced apart from the conductive protective member, electrically coupled to the conductive protective member, and the conductive pattern 360 or 960, spaced apart from the conductive frame 340, electrically coupled to the conductive frame 340.

In an embodiment, the conductive frame 340 may be structurally coupled to the non-conductive camera cover 320.

In an embodiment, the conductive frame 340 may include a first portion 341 overlapping a portion of the conductive protective member, a second portion overlapping another portion of the protective conductive member, and a third portion 342 or 344, extending across the opening 315 from the first portion 341 of the conductive frame 340 to the second portion of the conductive frame 340. The third portion 342 or 344 of the conductive frame 340 structurally coupled to the non-conductive camera cover 320.

According to an embodiment, an electronic device 300 may comprise a non-conductive rear cover 310, defining at least a portion of a rear exterior (i.e., second surface 200B) of the electronic device 300 and including a first surface 310A and a second surface 310B opposite to the first surface 310A, a non-conductive camera cover 320 disposed on the first surface 310A of the non-conductive rear cover 310 to cover an opening 315 of the non-conductive rear cover 310, a conductive ring 330 disposed on the first surface 310A of the non-conductive rear cover 310 to surround a periphery of the non-conductive camera cover 320, a conductive frame 340 including a first portion 341 or 343 disposed on the second surface 310B of the non-conductive rear cover 310 to overlap at least a portion of the conductive ring 330, and a second portion 342 or 344 extending from the first portion 341 or 343 to cross the opening 315 of the non-conductive rear cover 310 and coupled to the non-conductive camera cover 320, and a non-conductive plate 350 disposed below the non-conductive rear cover 310, and on which a conductive pattern 360 or 960 is formed. The conductive pattern 360 or 960 may comprise a first portion 961 overlapping the conductive frame 340, and a second portion 962 electrically connecting the first portion 961 of the conductive pattern 360 or 960 to a ground of the electronic device 300. The conductive ring 330 may be electrically connected to the ground through the conductive frame 340 spaced apart from the conductive ring 330, electrically coupled to the conductive ring 330, and the conductive pattern 360 or 960 spaced apart from the conductive frame 340, electrically coupled to the conductive frame 340.

In an embodiment, the conductive ring 330 may be electrically connected to the ground to form an electrostatic discharge (ESD) discharge path.

In an embodiment, the non-conductive camera cover 320 may comprise a protrusion 826 coupled to the second portion 342 or 344 of the conductive frame 340.

In an embodiment, the protrusion 826 of the non-conductive camera cover 320 may be fused to the second portion 342 or 344 of the conductive frame 340.

In an embodiment, the non-conductive plate 350 may comprise a surface 350A facing the non-conductive rear cover 310, having a recessed region 350R. The first portion 961 of the conductive pattern 360 or 960 may be formed on the recessed region 350R of the non-conductive plate 350.

In an embodiment, the electronic device 300 may comprise a camera 370 below the non-conductive camera cover 320. The non-conductive camera cover 320 may comprise a window portion 322 aligned with the camera 370. The conductive frame 340 may comprise an opening 345 aligned with the window portion 322 of the non-conductive camera cover 320.

In an embodiment, the non-conductive plate 350 may comprise an opening 355 aligned with the opening 345 of the conductive frame 340. A portion of the camera 370 may be positioned in the opening 355 of the non-conductive plate 350.

In an embodiment, the first portion 961 of the conductive pattern 360 or 960 may be formed around the opening 355 of the non-conductive plate 350.

In an embodiment, the electronic device 300 may comprise a conductive region 982 functioning at least partially as the ground, and a printed circuit board 380 disposed below the non-conductive plate 350. The second portion 962 of the conductive pattern 360 or 960 may be electrically connected to the conductive region 982 of the printed circuit board 380 through at least one element 994 or 1494.

In an embodiment, the conductive pattern 360 or 960 may be used as an antenna of the electronic device 300.

In an embodiment, another conductive pattern 1068 used as an antenna of the electronic device 300 may be formed on the non-conductive plate 350.

In an embodiment, the non-conductive camera cover 320 may comprise an upper portion, a lower portion opposite to the upper portion, and a central portion between the upper portion and the lower portion. The conductive ring 330 may comprise a first portion surrounding the upper portion of the non-conductive camera cover 320, a second portion surrounding the lower portion of the non-conductive camera cover 320, and a third portion extending from the first portion of the conductive ring 330 to the second portion of the conductive ring 330 to surround the central portion of the non-conductive camera cover 320. The conductive frame 340 may overlap the third portion of the first, second, and third portions of the conductive ring 330.

In an embodiment, the non-conductive camera cover 320 may be attached to the first surface 310A of the non-conductive rear cover 310.

In an embodiment, the first portion 341 or 343 of the conductive frame 340 may be attached to the second surface 310B of the non-conductive rear cover 310.

In an embodiment, the conductive frame 340 may include a third portion 343 disposed on the second surface 310B of the non-conductive rear cover 310 to be opposite the first portion 341 of the conductive frame 340. The second portion 342 or 344 of the conductive frame 340 may extend from the first portion 341 of the conductive frame 340, across the opening 315 of the non-conductive rear cover 310, to the third portion 343 of the conductive frame 340.

According to an embodiment, an electronic device 300 may comprise a non-conductive rear cover 310, defining at least a portion of a rear exterior (i.e., second surface 200B) of the electronic device 300 and including a first surface 310A and a second surface 310B opposite to the first surface 310A, a non-conductive camera cover 320 disposed on the first surface 310A of the non-conductive rear cover 310 to cover an opening 315 of the non-conductive rear cover 310, a conductive ring 330 disposed on the first surface 310A of the non-conductive rear cover 310 to surround a periphery of the non-conductive camera cover 320, a conductive frame 340 including a first portion 341 or 343 disposed on the second surface 310B of the non-conductive rear cover 310 to overlap at least a portion of the conductive ring 330, and a second portion 342 or 344 extending from the first portion 341 or 343 to cross the opening 315 of the non-conductive rear cover 310 and coupled to the non-conductive camera cover 320, and a non-conductive plate 350 disposed below the non-conductive rear cover 310, and on which a conductive pattern 360 or 960 is formed. The conductive ring 330 may be electrically connected to a ground of the electronic device 300 through the conductive frame 340 spaced apart from the conductive ring 330, electrically coupled to the conductive ring 330.

In an embodiment, the conductive ring 330 may be electrically connected to the ground to form an electrostatic discharge (ESD) discharge path.

In an embodiment, the non-conductive camera cover 320 may comprise a protrusion 826 fused to the second portion 342 or 344 of the conductive frame 340.

In an embodiment, the electronic device 300 may comprise a non-conductive plate 350 disposed below the non-conductive rear cover 310 and on which a conductive pattern 360 or 960 overlapping the conductive frame 340 is formed, a printed circuit board 380 including a conductive region 982 functioning at least partially as the ground, and disposed below the non-conductive plate 350, and at least one element 994 or 1494 disposed on the printed circuit board 380. The conductive ring 330 may be electrically connected to the conductive region 982 of the printed circuit board 380 through the conductive frame 340 spaced apart from the conductive ring 330, electrically coupled to the conductive ring 330, the conductive pattern 360 or 960 spaced apart from the conductive frame 340, electrically coupled to the conductive frame 340, and the at least one element 994 or 1494 electrically connected to the conductive pattern 360 or 960.

In an embodiment, the non-conductive plate 350 may comprise a surface 350A facing the non-conductive rear cover 310, having a recessed region 350R. The first portion 961 of the conductive pattern 360 or 960 may be formed on the recessed region 350R of the non-conductive plate 350.

The effects that may be obtained from the disclosure are not limited to those described above, and any other effects not mentioned herein will be clearly understood by those having ordinary knowledge in the art to which the disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a non-conductive rear cover, including a first surface defining at least a portion of a rear exterior of the electronic device and a second surface opposite to the first surface, the non-conductive rear cover defining an opening;
a non-conductive camera cover, covering the opening of the non-conductive rear cover, including a light transmittance portion;
a camera disposed below the light transmittance portion of the non-conductive camera cover, to be aligned with the light transmittance portion of the non-conductive camera cover;
a conductive ring, attached to the first surface of the non-conductive rear cover, surrounding the non-conductive camera cover; and
a conductive frame configured to fix the non-conductive camera cover to the non-conductive rear cover, the conductive frame at least partially overlapping the conductive ring and being spaced apart from the conductive ring,
wherein the conductive frame is electrically connected to a ground of the electronic device such that the conductive ring is electrically connected to the ground of the electronic device through an electrical coupling with the conductive frame spaced apart from the conductive ring.

2. The electronic device of claim 1, wherein the conductive ring is electrically connected to the ground of the electronic device to form an electrical path for an electrostatic discharge (ESD).

3. The electronic device of claim 1, wherein the conductive frame is structurally coupled to the non-conductive camera cover.

4. The electronic device of claim 3,
wherein the conductive frame includes:
a first portion overlapping a portion of the conductive ring,
a second portion overlapping another portion of the conductive ring, and
a third portion, extending across the opening of the non-conductive camera cover from the first portion of the conductive frame to the second portion of the conductive frame, and
wherein the third portion of the conductive frame is structurally coupled to the non-conductive camera cover.

5. The electronic device of claim 4, wherein the non-conductive camera cover includes at least one protrusion coupled to the third portion of the conductive frame.

6. The electronic device of claim 5, wherein the at least one protrusion of the non-conductive camera cover extends through the third portion of the conductive frame and is fused to the third portion of the conductive frame.

7. The electronic device of claim 4, further comprising:
an adhesive material attaching the third portion of the conductive frame to the non-conductive camera cover.

8. The electronic device of claim 1, comprising:
a non-conductive plate disposed below the conductive frame; and
a conductive pattern, formed on the non-conductive plate, spaced apart from the conductive frame, and at least partially overlapping the conductive frame,
wherein the conductive ring is electrically connected to the ground of the electronic device through:
the electrical coupling with the conductive frame spaced apart from the conductive ring, and
an electrical coupling between the conductive frame and the conductive pattern spaced apart from the conductive frame.

9. The electronic device of claim 8,
wherein the non-conductive plate includes a surface facing the conductive frame,
wherein a recessed region is formed on the surface of the non-conductive plate, and
wherein at least a portion of the conductive pattern is formed on the recessed region of the non-conductive plate.

10. The electronic device of claim 9, comprising:
a printed circuit board (PCB) including a ground region configured to function at least partially as the ground of the electronic device,
wherein the conductive pattern is electrically connected to the ground region of the PCB.

11. The electronic device of claim 10, further comprising:
a conductive connector, disposed on the PCB, connecting the conductive pattern to the ground region of the PCB.

12. The electronic device of claim 11,
wherein the non-conductive plate includes another surface, opposite to the surface of the non-conductive plate, facing the PCB, and
wherein the conductive pattern includes:
a first section, formed on the surface of the non-conductive plate, overlapping the conductive frame,
a second section, formed on the another surface of the non-conductive plate, being in contact with the conductive connector, and
a third section extending through the non-conductive plate from the first section of the conductive pattern to the second section of the conductive pattern.

13. The electronic device of claim 8,
wherein the non-conductive plate includes an opening portion defining an opening in which a portion of the camera is disposed, and
wherein at least a portion of the conductive pattern is formed on the opening portion of the non-conductive plate.

14. The electronic device of claim 8, wherein the conductive pattern is used as at least a portion of an antenna of the electronic device.

15. The electronic device of claim 8, further comprising:
another conductive pattern, formed on the non-conductive plate, used as at least a portion of another antenna of the electronic device.

16. The electronic device of claim 1,
wherein the conductive frame defines an opening aligned with the light transmittance portion of the non-conductive camera cover, and
wherein a portion of the camera is disposed in the opening of the conductive frame.

17. The electronic device of claim 1, wherein the conductive ring is attached to an edge portion of the non-conductive camera cover.

18. An electronic device comprising:
a non-conductive rear cover, including a first surface defining at least a portion of a rear exterior of the electronic device and a second surface opposite to the first surface, the non-conductive rear cover defining an opening;
a non-conductive camera cover, attached to the first surface of the non-conductive rear cover to cover the opening of the non-conductive rear cover, the non-conductive camera cover including a light transmittance portion;
a camera, disposed below the light transmittance portion of the non-conductive camera cover, configured to receive light through the light transmittance portion of the non-conductive camera cover;
a conductive protective member disposed on the first surface of the non-conductive rear cover, surrounding a periphery portion of the non-conductive camera cover;
a conductive frame, attached to the second surface of the non-conductive rear cover to at least partially overlap the conductive protective member;
a non-conductive plate, disposed below the conductive frame; and
a conductive pattern, formed on the non-conductive plate, spaced apart from the conductive frame, and at least partially overlapping the conductive frame,
wherein the conductive protective member is electrically connected to a ground of the electronic device through:
the conductive frame, spaced apart from the conductive protective member, electrically coupled to the conductive protective member, and
the conductive pattern, spaced apart from the conductive frame, electrically coupled to the conductive frame.

19. The electronic device of claim 18, wherein the conductive frame is structurally coupled to the non-conductive camera cover.

20. The electronic device of claim 19,
wherein the conductive frame includes:
a first portion overlapping a portion of the conductive protective member,
a second portion overlapping another portion of the protective conductive member, and
a third portion, extending across the opening from the first portion of the conductive frame to the second portion of the conductive frame, and
wherein the third portion of the conductive frame structurally coupled to the non-conductive camera cover.
